(19) United States
(12) Patent Application Publication
(10) Pub. No.: US 2012/0228840 A1
(43) Pub. Date: Sep. 13, 2012

(54) Foldable laptop trolley

(75) Inventor: Shou Qiang, Hong Kong (HK)

(73) Assignee: IP Power Holdings Limited

(21) Appl. No.: 13/065,029

(22) Filed: Mar. 11, 2011

(51) Int. Cl. B62B 3/02

(52) U.S. Cl. 280/42

(57) ABSTRACT

A foldable laptop trolley includes a table top, two side frames for supporting the table top, a table top assembly supported on the top supporting members, a wheel assembly which includes a plurality of lockable wheels coupling with the below supporting members, and a foldable frame operatively coupled with the side frames to fold the foldable laptop trolley between an unfolded position and a folded position, wherein the foldable frame includes two supporting elements pivotally coupled with each other two inner ends thereof and pivotally coupled with the side frames at inner edges of uppers of the first supporting members.

### BACKGROUND OF THE PRESENT INVENTION

1. Field of Invention

The present invention relates to a laptop trolley, more particularly to a foldable laptop trolley having a table top and two side frames for supporting the table top.

2. Description of Related Arts

Over the last decade, the computer industry has been improved intensely. The sizes of portable computers are becoming smaller and smaller, and portable computers are eventually downsized into “laptop computers”, and Laptop computers have become commonplace in recent1years.

A laptop has a small size, so it is convenient to use on the user's lap or other places. But its small size leads to its relatively bad capability of radiating heat. So when a laptop is under working state, it will be better that the laptop is placed horizontally and retain a air channel between its back and the plane which the laptop is located on for radiating heat.

In order to make the time of the user a more pleasant one, numerous accessories have been developed for the laptop. Some of the most important of these are the accessories that elevate and support the laptop while the user has the laptop on their lap or on another surface. But these accessories are just accessories, they are lack of necessary structure which can elevate and support the laptop at a suitable height to settle the user into a correct sitting posture to prevent the user from backache, more particularly lumbar spondylosis. The user will feel a complaint of the back when the user use a laptop supported on these accessories on his/her laps for a long period of time.

The conventional tables or computer tables have the necessary structure and can elevate and support the laptop at a suitable height, but the most conventional computer tables are designed for desktop computer and they are bulky in size and unsuitable to move. So they cannot follow the property of portability of the laptop.

### SUMMARY OF THE PRESENT INVENTION

The invention is advantageous in that it provides a foldable laptop trolley, which provides a table top supported by strong foldable frame structure to well support the laptop.

Another advantage of the invention is to provide a foldable laptop trolley which is simple in structure, small in size and easy to move.

Another advantage of the invention is to provide a foldable laptop trolley which can be quickly and easily folded into a compact unit for carriage and storage and unfolded for use.

Another advantage of the invention is to provide a foldable laptop trolley which has a rigid structure to provide a stable operating environment for the hardware of the laptop.

Another advantage of the invention is to provide a foldable laptop trolley which can provide an operating environment which is easy to radiate heat for the laptop.

Another advantage of the invention is to provide a foldable laptop trolley which can provide a comfortable operating environment for the user of the laptop.

Another advantage of the invention is to provide a foldable laptop trolley and the foldable frame of the foldable laptop trolley is provided at the back side apart from the body of the user to provide a convenient operating environment for the user of the laptop.

Another advantage of the present invention is to provide a foldable laptop trolley, wherein different reinforcing mechanisms are incorporated with the foldable laptop trolley to secure the foldable laptop trolley at the unfolded position.

Another advantage of the invention is to provide a foldable laptop trolley which can bring a healthy sitting posture to the user of the laptop when the user is using laptop.

Another advantage of the invention is to provide a foldable laptop trolley which can minimize the prevalence rate of lumbar spondylosis of the user of laptop.

Another advantage of the present invention is to provide a foldable laptop trolley, wherein no expensive or complicate mechanical structure is required to employ in the present invention in order to achieve the above mentioned objects. Therefore, the present invention successfully provides an economic and efficient solution for providing a rigid foldable structure of the foldable laptop trolley and a reinforced support configuration to support the laptop.

Additional advantages and features of the invention will become apparent from the description which follows, and may be realized by means of the instrumentalities and combinations particular point out in the appended claims.

According to the present invention, the foregoing and other objects and advantages are attained by a foldable laptop trolley, comprising:

two spaced apart side frames, wherein each of the side frames comprises a first supporting member, a second supporting member, a top supporting member supported between the first supporting member and the second supporting member and a below supporting member coupling with the first supporting member and the second supporting member;

a table top assembly, which is supported on the top supporting members;

a wheel assembly, which comprises a plurality of lockable wheels coupling with the below supporting members; and

a foldable frame operatively coupled with the side frames to fold the foldable laptop trolley between an unfolded position and a folded position, wherein the foldable frame comprises two supporting elements pivotally coupled with each other two inner ends thereof and pivotally coupled with the side frames at inner edges of uppers of the first supporting members.

In accordance with another aspect of the invention, the present invention comprises a foldable supporting frame, which comprises two folding arms movably coupling with the first supporting elements of the side frames respectively to retain the distance between the side frames at the unfolded position ; a secure lock for releasably locking the foldable supporting frame at the unfolded position, wherein the secure lock comprises a first locker provided at the first pivot point and a second locker pivotally coupled with the uppers of two the folding arms ; a footrest, wherein the footrest comprises two resting elements pivotally coupled with each other two inner edges thereof to define a footrest pivot point and pivotally coupled with two the below supporting members of the side frames at inner edges of the below supporting members respectively ; two linking elements to retain stable structure of the foldable laptop trolley at the unfolded position, wherein two the linking elements coupled with the supporting elements and pivotally coupled with the first supporting members respectively ; wherein two said supporting elements pivotally coupled with each other two inner ends thereof to define a first pivot point, and the foldable supporting frame further comprises a linking member coupled with the secure lock and vertically and downwardly coupled with the footrest pivot point pivotally to retain the distance between the foldable supporting frame and the footrest at the unfolded position, and the table top comprises a plurality of magnetic connectors and the top supporting members are made of ferrous metal or ferroalloy so that the table top and the top supporting member and the top supporting members is snapped on each other.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a foldable laptop trolley according to a preferred embodiment of the present invention, illustrating the foldable laptop trolley being folded at an unfolded position.

FIG. 2 is a side view of the foldable laptop trolley according to the above preferred embodiment of the present invention, illustrating the foldable laptop trolley being folded at a folded position.

FIG. 3 is a perspective view of the foldable laptop trolley at the folded position according to the above preferred embodiment of the present invention.

FIG. 4 is a perspective view of the foldable laptop trolley according to the above preferred embodiment of the present invention, illustrating the folding operation of the foldable laptop trolley.

FIG. 5 is a perspective view of a secure locker of the foldable laptop trolley 20 according to the above preferred embodiment of the present invention.

### DETAILED DESCRIPTION OF THE PREFERRED EMBODIMENT

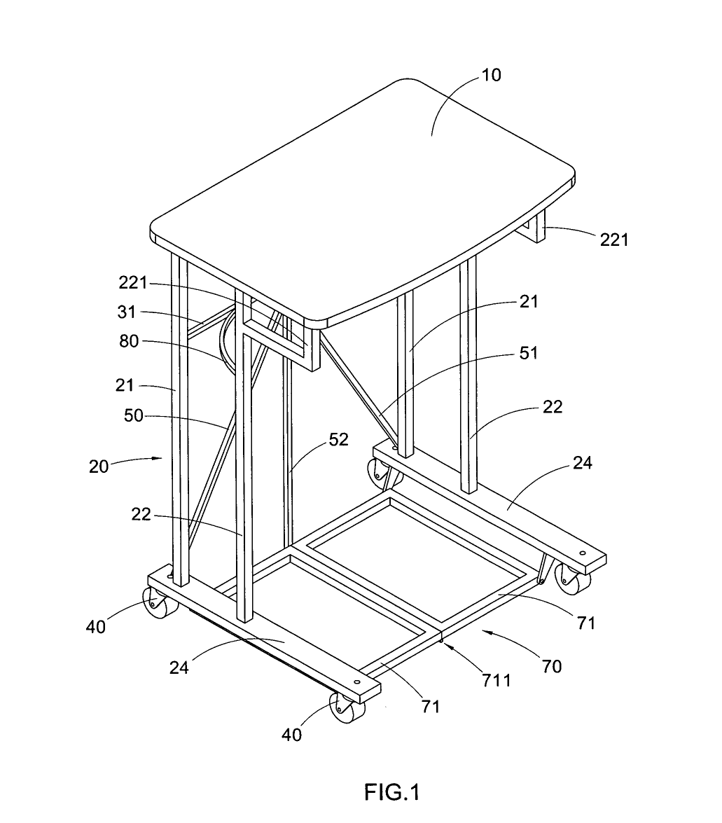

Referring to FIG. 1 of the drawings, a foldable laptop trolley according to a preferred embodiment of the present invention, wherein the foldable laptop trolley comprises a table top 10 assembly, two spaced apart side frames 20, a foldable frame 30 and a wheel 40.

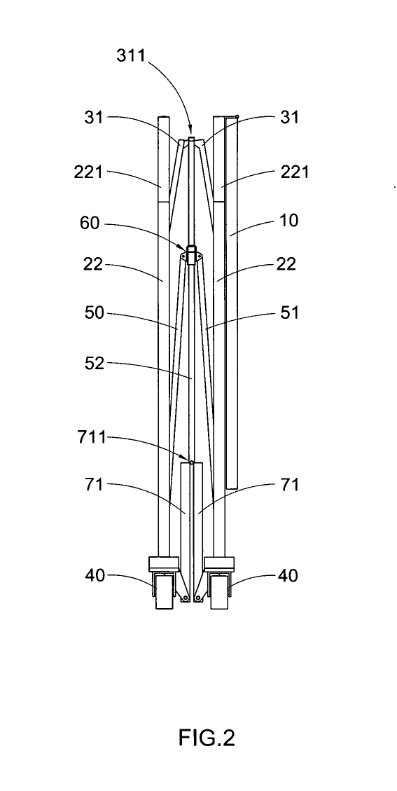

As shown in FIG. 1 and FIG. 2 of the drawings, each of two side frames 20 comprises a first supporting member 21, a second supporting member 22, a top supporting member 23 supported between the first supporting member 21 and the second supporting member 22 and a below supporting member 24 coupling with the first supporting member 21 and the second supporting member 22, wherein the second supporting member 22 comprises a side supporting member 221 coupled with the top supporting member 23 for supporting the top supporting member 23.

As shown in FIG. 1 of the drawings, the table top 10 is supported on the top supporting members 23 for elevating and supporting a laptop. The table top 10 can be a separated panel or a panel revolvably provided at one of two top supporting members. The table top 10 is made of magnetic material or comprises a plurality of magnetic connectors and the top supporting members 23 are made of ferrous metal or ferroalloy so that the table top 10 and the top supporting members 23 are snapped on each other. The top supporting members 23 can also comprises a plurality of adaptors corresponding to the magnetic connectors of the table top 10 or the magnetic table top 10 so that the table top 10 and the top supporting members 23 are snapped on each other. The table top 10 is supported on the top supporting members 23 when the foldable laptop trolley is fold at unfolded position under working state. At this time, if the table top 10 is provided at one of the two top supporting members 23, the table top 10 has been revolvably move from the top supporting member 23 which the table top is provided at to another top supporting member 23 so that the table top 10 is supported on the two top supporting members 23.

As shown in FIG. 1 of the drawings, the foldable frame 30 is operatively coupled with the side frames 20 to fold the foldable laptop trolley between an unfolded position and a folded position, wherein the foldable frame 30 comprises two supporting elements 31 pivotally coupled with each other two inner ends thereof and pivotally coupled with the two side frames at inner edges of uppers of the first supporting members respectively, wherein two the supporting elements 31 pivotally coupled with each other two inner ends thereof to define a first pivot point 311 to retain the distance between the two side frames 20 at the unfolded position and support the foldable laptop trolley at a stable state at the unfolded position.

As shown in FIG. 1 of the drawings, the wheel 40 comprises a plurality of lockable wheels coupling with the below supporting members 24 so that the foldable laptop trolley is easy to move.

Accordingly, the width of the foldable frame 30 correspondingly matches with the distance between the two top supporting members 23, and the width of the table top 10 correspondingly matches with the distance between the two top supporting members 23, the length of the table top 10 correspondingly matches with the length of each of the two top supporting members 23 so that the table top can be securely and exactly supported by the two top supporting members 23.

As shown in FIG. 1 of the drawings, the foldable laptop trolley according to a preferred embodiment of the present invention further comprises a foldable supporting frame 50, which comprises two folding arms 51 movably coupling with the two first supporting elements 21 of the side frames 20 respectively to retain the distance between the two side frames 20 at the unfolded position and support the foldable laptop trolley at a stable state at the unfolded position.

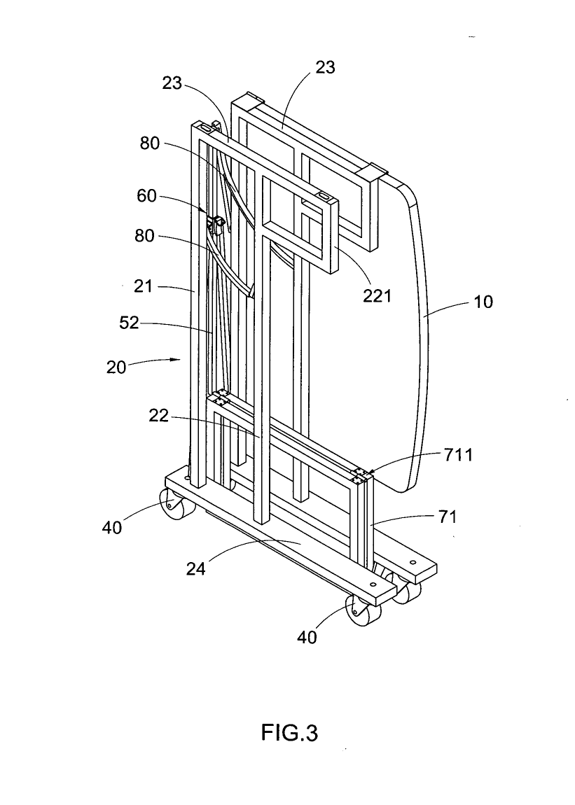

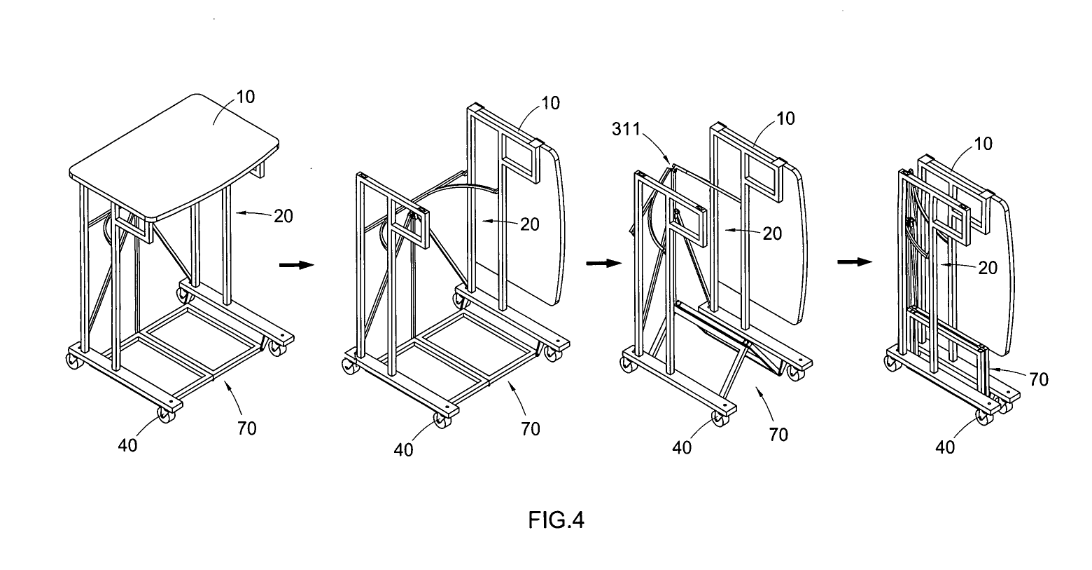

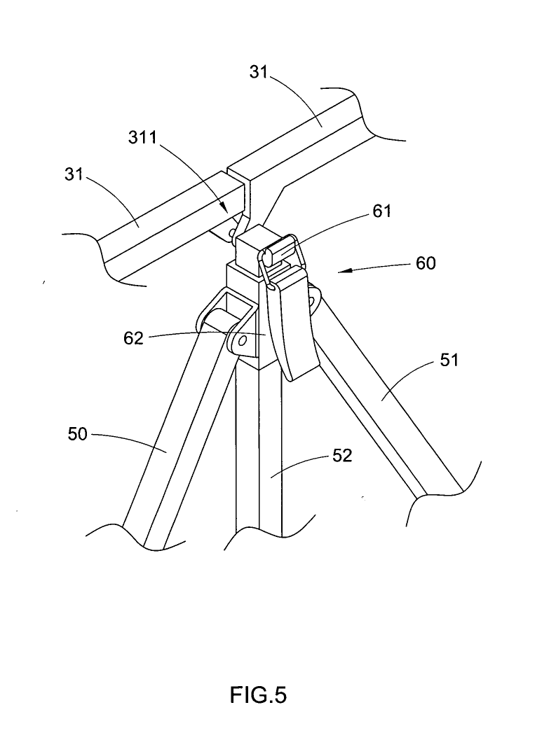

As shown in FIG. 1, FIG. 2, FIG. 3 and FIG. 4 of the drawings, the foldable laptop trolley according to a preferred embodiment of the present invention further comprises a secure lock 60 for releasably locking the foldable supporting frame 50 at the unfolded position. As shown in FIG. 5, the secure lock comprises a first locker 51 provided at the first pivot point and a second locker 52 pivotally coupled with the uppers of the two folding arms 51.

As shown in FIG. 1, FIG. 2, FIG. 3 and FIG. 4 of the drawings, the foldable laptop trolley according to a preferred embodiment of the present invention further comprises a footrest 70, and the footrest 70 comprises two resting elements 71 pivotally coupled with each other two inner edges thereof to define a footrest pivot point 711 and pivotally coupled with the two below supporting members 24 of the side frames 20 at inner edges of the two below supporting members respectively.

As shown in FIG. 1, FIG. 2, FIG. 3 and FIG. 4 of the drawings, the foldable supporting frame further comprises a linking member 52 coupled with the secure lock 60 and vertically and downwardly coupled with the footrest pivot point 711 pivotally to retain the distance between the foldable supporting frame 50 and the footrest 70 at the unfolded position and support the foldable laptop trolley at a stable state at the unfolded position.

As shown in FIG. 1, FIG. 2, FIG. 3 and FIG. 4 of the drawings, the foldable laptop trolley of the present invention further comprises two linking elements 80 coupled with the supporting elements 31 and pivotally coupled with the two first supporting members 21 respectively to retain the distance between the two side frames 20 at the unfolded position and support the foldable laptop trolley at a stable state at the unfolded position.

It is worth to mention that different mechanisms are used for retaining the foldable laptop trolley at the unfolded position. The foldable laptop trolley is constructed of durable powder coated steel frame to provided sturdy structure of the foldable laptop trolley. The weight of the foldable frame 30 retains the foldable frame 30 at the unfolded position and the distance between the two side frames 20 at the unfolded position and support the foldable laptop trolley at a stable state at the unfolded position. The weight of the table top 10 and the laptop supported on the table top 10 will prevent the linking member 52 from moving upwardly so as to ensure the foldable frame 30 and the laptop trolley at unfolded position. The foldable supporting frame 50 retains the distance between the two side frames 20 at the unfolded position and support the foldable laptop trolley at a stable state at the unfolded position. The linking elements retain the foldable frame 30 at the unfolded position to retain the distance between the two side frames 20 at the unfolded position.

As shown in FIG. 2 of the drawings, the foldable laptop trolley of the present invention is folded into a flat for easy storage and transportation at a folded position so that the foldable laptop trolley fits behind a door or under a bed when folded. At first, the table top 10 provided at one of the two top supporting members 23 is revolvably move from another top supporting member 23 to the top supporting member 23 which the table top is provided at so that the table top 10 is folded. And then, the foldable frame 30 moves upwardly and is folded to ensure that the linking member 52 and the footrest move upwardly so that the foldable laptop trolley is folded at the folded position. The foldable frame 30, the foldable supporting frame 50, the resting elements of the footrest 70 and the two linking elements 80 are folded between two side frames 20 to retain a distance between two side frames 20 so that the foldable laptop trolley can retain standing state without leaning on other objects at the folded position.

It is worth to mention that a user need not additional tools to ensure that the foldable laptop trolley is folded at the folded position or at the unfolded position.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A foldable laptop trolley, comprising:
two spaced apart side frames, wherein each of said side frames comprises a first supporting member, a second supporting member, a top supporting member supported between said first supporting member and said second supporting member and a below supporting member coupling with said first supporting member and said second supporting member;
a table top assembly, which is supported on said top supporting members;
a wheel assembly, which comprises a plurality of lockable wheels coupling with said below supporting members; and
a foldable frame operatively coupled with said side frames to fold said foldable laptop trolley between an unfolded position and a folded position, wherein said foldable frame comprises two supporting elements pivotally coupled with each other two inner ends thereof and pivotally coupled with said side frames at inner edges of uppers of said first supporting members.

2. The foldable laptop trolley, as recited in claim 1, wherein said foldable laptop trolley comprises a foldable supporting frame, which comprises two folding arms movably coupling with said first supporting elements of said side frames respectively to retain the distance between said side frames at said unfolded position.

3. The foldable laptop trolley, as recited in claim 1, wherein two said supporting elements pivotally coupled with each other two inner ends thereof to define a pivot point.

4. The foldable laptop trolley, as recited in claim 2, wherein two said supporting elements pivotally coupled with each other two inner ends thereof to define a pivot point.

5. The foldable laptop trolley, as recited in claim 3, further comprising a secure lock for releasably locking said foldable supporting frame at said unfolded position, wherein said secure lock comprises a first locker provided at said first pivot point and a second locker pivotally coupled with the uppers of two said folding arms.

6. The foldable laptop trolley, as recited in claim 4, further comprising a secure lock for releasably locking said foldable supporting frame at said unfolded position, wherein said secure lock comprises a first locker provided at said first pivot point and a second locker pivotally coupled with the uppers of two said folding arms.

7. The foldable laptop trolley, as recited in claim 1, further comprising a footrest, wherein said footrest comprises two resting elements pivotally coupled with each other two inner edges thereof to define a footrest pivot point and pivotally coupled with two said below supporting members of said side frames at inner edges of said below supporting members respectively.

8. The foldable laptop trolley, as recited in claim 2, further comprising a footrest, wherein said footrest comprises two resting elements pivotally coupled with each other two inner edges thereof to define a footrest pivot point and pivotally coupled with two said below supporting members of said side frames at inner edges of said below supporting members respectively.

9. The foldable laptop trolley, as recited in claim 3, further comprising a footrest, wherein said footrest comprises two resting elements pivotally coupled with each other two inner edges thereof to define a footrest pivot point and pivotally coupled with two said below supporting members of said side frames at inner edges of said below supporting members respectively.

10. The foldable laptop trolley, as recited in claim 4, further comprising a footrest, wherein said footrest comprises two resting elements pivotally coupled with each other two inner edges thereof to define a footrest pivot point and pivotally coupled with two said below supporting members of said side frames at inner edges of said below supporting members respectively.

11. The foldable laptop trolley, as recited in claim 5, further comprising a footrest, wherein said footrest comprises two resting elements pivotally coupled with each other two inner edges thereof to define a footrest pivot point and pivotally coupled with two said below supporting members of said side frames at inner edges of said below supporting members respectively.

12. The foldable laptop trolley, as recited in claim 6, further comprising a footrest, wherein said footrest comprises two resting elements pivotally coupled with each other two inner edges thereof to define a footrest pivot point and pivotally coupled with two said below supporting members of said side frames at inner edges of said below supporting members respectively.

13. The foldable laptop trolley, as recited in claim 1, further comprising two linking elements to retain stable structure of said foldable laptop trolley at said unfolded position, wherein two said linking elements coupled with said supporting elements and pivotally coupled with said first supporting members respectively.

14. The foldable laptop trolley, as recited in claim 2, further comprising two linking elements to retain stable structure of said foldable laptop trolley at said unfolded position, wherein two said linking elements coupled with said supporting elements and pivotally coupled with said first supporting members respectively.

15. The foldable laptop trolley, as recited in claim 3, further comprising two linking elements to retain stable structure of said foldable laptop trolley at said unfolded position, wherein two said linking elements coupled with said supporting elements and pivotally coupled with said first supporting members respectively.

16. The foldable laptop trolley, as recited in claim 4, further comprising two linking elements to retain stable structure of said foldable laptop trolley at said unfolded position, wherein two said linking elements coupled with said supporting elements and pivotally coupled with said first supporting members respectively.

17. The foldable laptop trolley, as recited in claim 5, further comprising two linking elements to retain stable structure of said foldable laptop trolley at said unfolded position, wherein two said linking elements coupled with said supporting elements and pivotally coupled with said first supporting members respectively.

18. The foldable laptop trolley, as recited in claim 6, further comprising two linking elements to retain stable structure of said foldable laptop trolley at said unfolded position, wherein two said linking elements coupled with said supporting elements and pivotally coupled with said first supporting members respectively.

19. The foldable laptop trolley, as recited in claim 7, further comprising two linking elements to retain stable structure of said foldable laptop trolley at said unfolded position, wherein two said linking elements coupled with said supporting elements and pivotally coupled with said first supporting members respectively.

20. The foldable laptop trolley, as recited in claim 12, further comprising two linking elements to retain stable structure of said foldable laptop trolley at said unfolded position, wherein two said linking elements coupled with said supporting elements and pivotally coupled with said first supporting members respectively.

21. The foldable laptop trolley, as recited in claim 7, wherein said foldable supporting frame further comprises a linking member coupled with said secure lock and vertically and downwardly coupled with said footrest pivot point pivotally to retain the distance between said foldable supporting frame and said footrest at said unfolded position.

22. The foldable laptop trolley, as recited in claim 12, wherein said foldable supporting frame further comprises a linking member coupled with said secure lock and vertically and downwardly coupled with said footrest pivot point pivotally to retain the distance between said foldable supporting frame and said footrest at said unfolded position.

23. The foldable laptop trolley, as recited in claim 19, wherein said foldable supporting frame further comprises a linking member coupled with said secure lock and vertically and downwardly coupled with said footrest pivot point pivotally to retain the distance between said foldable supporting frame and said footrest at said unfolded position.

24. The foldable laptop trolley, as recited in claim 20, wherein said foldable supporting frame further comprises a linking member coupled with said secure lock and vertically and downwardly coupled with said footrest pivot point pivotally to retain the distance between said foldable supporting frame and said footrest at said unfolded position.

25. The foldable laptop trolley, as recited in claim 1, wherein said table top comprises a plurality of magnetic connectors and said top supporting members are made of ferrous metal or ferroalloy so that said table top and said top supporting member are snapped on each other.

26. The foldable laptop trolley, as recited in claim 2, wherein said table top comprises a plurality of magnetic connectors and said top supporting members are made of ferrous metal or ferroalloy so that said table top and said top supporting member are snapped on each other.

27. The foldable laptop trolley, as recited in claim 3, wherein said table top comprises a plurality of magnetic connectors and said top supporting members are made of ferrous metal or ferroalloy so that said table top and said top supporting member are snapped on each other.

28. The foldable laptop trolley, as recited in claim 4, wherein said table top comprises a plurality of magnetic connectors and said top supporting members are made of ferrous metal or ferroalloy so that said table top and said top supporting member are snapped on each other.

29. The foldable laptop trolley, as recited in claim 5, wherein said table top comprises a plurality of magnetic connectors and said top supporting members are made of ferrous metal or ferroalloy so that said table top and said top supporting member are snapped on each other.

30. The foldable laptop trolley, as recited in claim 6, wherein said table top comprises a plurality of magnetic connectors and said top supporting members are made of ferrous metal or ferroalloy so that said table top and said top supporting member are snapped on each other.

31. The foldable laptop trolley, as recited in claim 7, wherein said table top comprises a plurality of magnetic connectors and said top supporting members are made of ferrous metal or ferroalloy so that said table top and said top supporting member are snapped on each other.

32. The foldable laptop trolley, as recited in claim 12, wherein said table top comprises a plurality of magnetic connectors and said top supporting members are made of ferrous metal or ferroalloy so that said table top and said top supporting member are snapped on each other.

33. The foldable laptop trolley, as recited in claim 13, wherein said table top comprises a plurality of magnetic connectors and said top supporting members are made of ferrous metal or ferroalloy so that said table top and said top supporting member are snapped on each other.

34. The foldable laptop trolley, as recited in claim 20, wherein said table top comprises a plurality of magnetic connectors and said top supporting members are made of ferrous metal or ferroalloy so that said table top and said top supporting member are snapped on each other.

35. The foldable laptop trolley, as recited in claim 21, wherein said table top comprises a plurality of magnetic connectors and said top supporting members are made of ferrous metal or ferroalloy so that said table top and said top supporting member are snapped on each other.

36. The foldable laptop trolley, as recited in claim 24, wherein said table top comprises a plurality of magnetic connectors and said top supporting members are made of ferrous metal or ferroalloy so that said table top and said top supporting member are snapped on each other.
